(19) United States
(12) Patent Application Publication
(10) Pub. No.: US 2011/0308825 A1
(43) Pub. Date: Dec. 22, 2011

(54) Automatic fire extinguishing equipment of a fume hood

(75) Inventor: Chia-Chun Lee, Taipei City (TW)

(73) Assignee: Acxing Industrial Co., Ltd.

(21) Appl. No.: 11/826,038

(22) Filed: Jul. 11, 2007

(51) Int. Cl. A62C 3/00

(52) U.S. Cl. 169/65

(57) ABSTRACT

Automatic fire extinguishing equipment of a fume hood includes a cabinet having a workbench, a vent pipe, and ventilation equipment. In front of the cabinet is a window panel. Top rim of the workbench has first and second detection elements, and automatic fire extinguishing equipment mechanisms. The ventilation equipment contains a fire damper. When fire occurs at the workbench from experiments, the first detection element detects a fire signal first to issue alarming sound (or alerting flash) promptly, the ventilation equipment shutdowns, with the fire damper closed for closing the vent pipe. When the second detection element detects a smoke or high temperature signal, the window panel is closed, with the automatic fire extinguishing equipment mechanisms activated automatically to terminate flame, thereby preventing thick smoke or flame from channeling into the vent pipe to spread the fire, and preventing the fume hood from starting a cascade of fire.

### BACKGROUND OF THE INVENTION

a) Field of the Invention The present invention relates to automatic fire extinguishing equipment of a fume hood, and more particularly to automatic fire extinguishing equipment of a fume hood that can prevent fire from spreading and expanding, thereby enabling the fume hood to actually achieve a fire-proof effect.

b) Description of the Prior Art

Not all existing fume hoods used in chemical experiments are provided with automatic fire extinguishing equipment. Referring to FIGS. 1 to 3, there are some more advanced products including a cabinet 1, which is provided with a workbench 11, above which is provided with a vent pipe 12 with ventilation equipment 13 being located close to a pipe opening of the vent pipe 12, and a front side of which is provided with a movable window panel 14. Top rim of the workbench 11 is disposed with automatic fire extinguishing equipment mechanisms 15, and middle of the workbench 11 is installed with a temperature sensor 16. When fire occurs at the workbench 11 from chemical experiments, the temperature sensor 16 will detect high temperature and then the automatic fire extinguishing equipment mechanisms 15 will be activated to spray for extinguishing the fire. However, due to that the ventilation equipment 13 is not turned off when the fire occurs, and that the vent pipe 12 is till opened, most of thick smoke or even high temperature or flame will be sucked into the vent pipe 12, prohibiting the temperature sensor 16 from being able to detect the high temperature to activate the automatic fire extinguishing equipment mechanisms 15 for terminating the fire in the shortest time. In addition, as most of the vent pipes 12 of the fume hoods in laboratories are serially connected, the flame will induce the fire to other fume hoods or processing equipment through the connected vent pipes, causing a severe disaster; therefore, improvement is actually needed.

### SUMMARY OF THE INVENTION

The primary object of the present invention is to provide automatic fire extinguishing equipment of a fume hood, to prevent the fume hood from starting fire accidentally in experiments, and to avoid the fire from spreading and expanding, thereby enabling the fume hood to actually achieve a fire-proof effect.

The aforementioned automatic fire extinguishing equipment of a fume hood is composed of a cabinet which is provided with a workbench. A vent pipe is located above the cabinet, and ventilation equipment is installed at a place close to a pipe opening of the vent pipe. A movable window panel is located in a front side of the cabinet, and a top rim of the workbench is provided with a first and a second detecting element, as well as automatic fire extinguishing equipment mechanisms. A front end or a rear end of the ventilation equipment is provided with a fire damper which is driven by a drive mechanism, such that when the fire occurs accidentally at the workbench, a fire signal can be first detected by the first detection element to issue alarming sound or alerting flash in real time, thereby notifying personnel to pay attention to and prepare against the fire. On the other hand, the ventilation equipment will be automatically stopped by the drive mechanism and the fire damper will be closed to close the vent pipe. When a thick smoke or high temperature signal is detected by the second detection element, the window panel will be closed through the drive mechanism, and the automatic fire extinguishing equipment mechanisms will be activated to terminate the flame, so as to prevent the thick smoke or flame from channeling into the vent pipe to spread and expand the fire, which will result in burning other connected fume hoods or processing equipment; therefore, the fume hood can actually achieve a fire-proof effect.

The aforementioned first detection element of the automatic fire extinguishing equipment of the fume hood can be a flame detector or other detector that can sense the flame, in order to detect the flame signal momentarily.

The aforementioned second detection element of the automatic fire extinguishing equipment of the fume hood can be a smoke or temperature detector, in order to detect the thick smoke or high temperature signal.

The aforementioned first detection element, second detection element, a manual activation device and a shutdown device of the automatic fire extinguishing equipment mechanisms, as well as the drive mechanism of the fire damper and the window panel, are connected respectively to a control host which is used to interpret the detected signal to control shutdown of the ventilation equipment, closure of the fire damper and the window panel, issuing of an alarming signal, as well as an operation of the automatic fire extinguishing equipment.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a perspective view of a conventional fume hood.

FIGS. 2 and 3 show schematic views of an operation of a conventional fume hood.

FIG. 4 shows a perspective view of the present invention.

FIGS. 5 and 6 show structural views of the present invention.

FIG. 7 shows a circuit block diagram of the present invention.

FIG. 8 shows a flow chart of an operation of the present invention.

FIG. 9 shows a schematic view of an operation of a fire damper of the present invention.

FIG. 10 shows a schematic view of an operation of a window panel of the present invention.

FIG. 11 shows a schematic view of a spraying operation of automatic fire extinguishing equipment mechanisms of the present invention

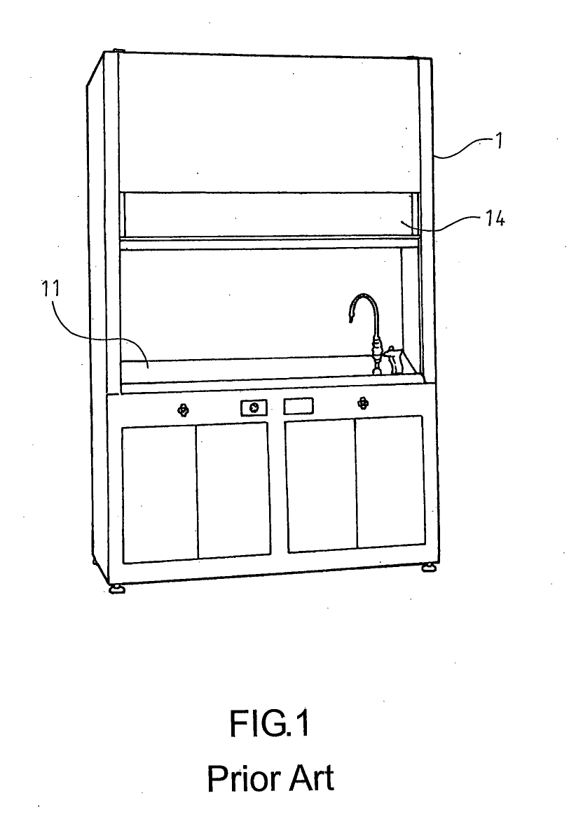

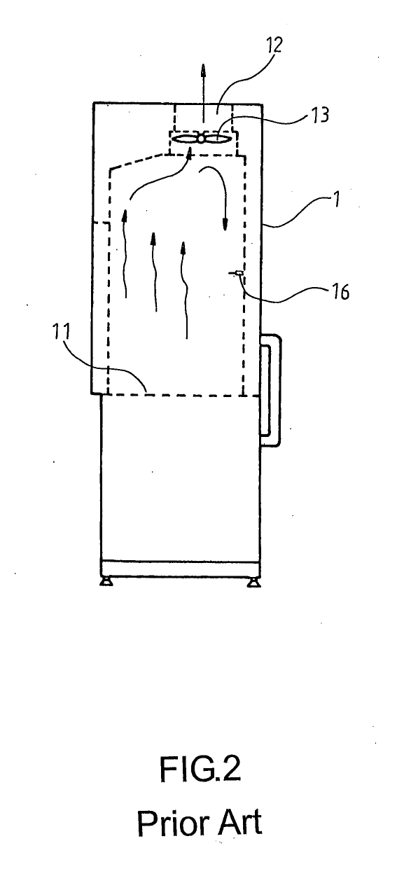

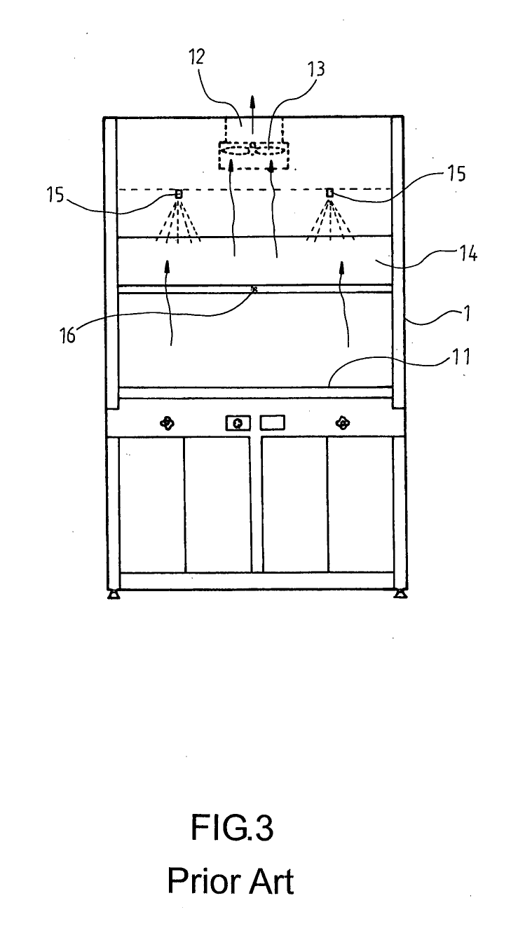

### DETAILED DESCRIPTION OF THE PREFERRED EMBODIMENTS

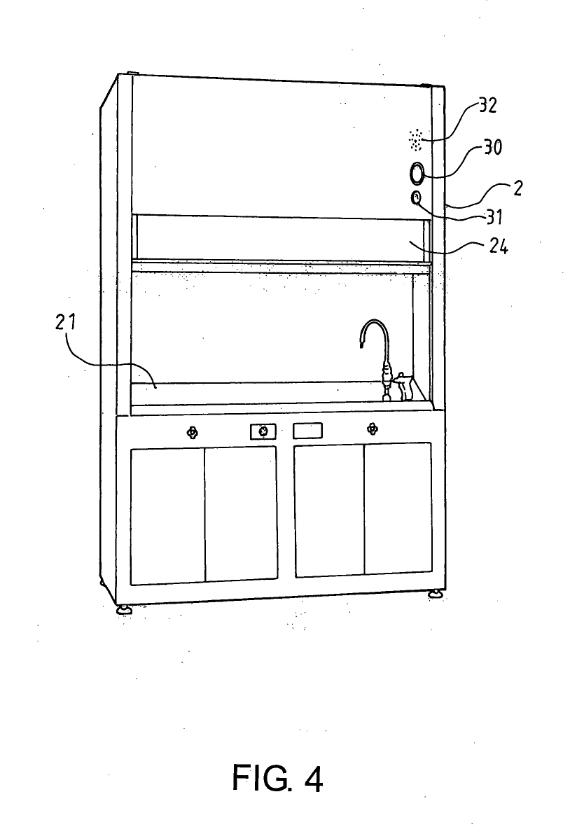

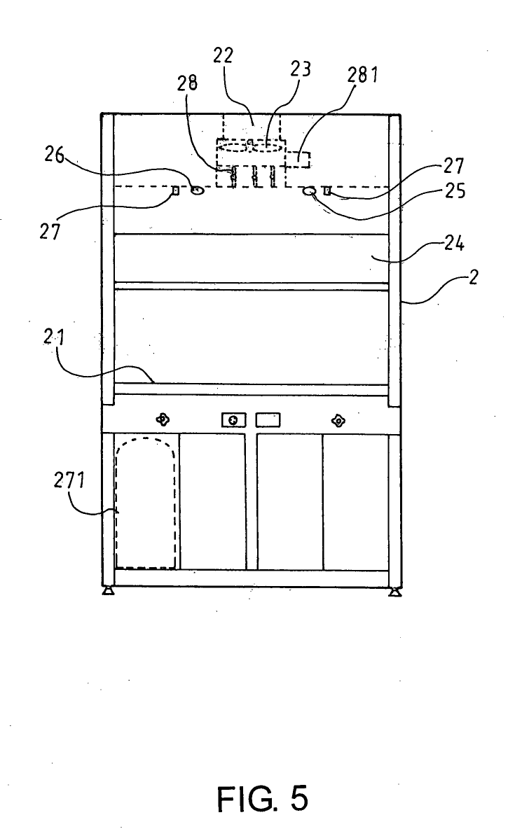

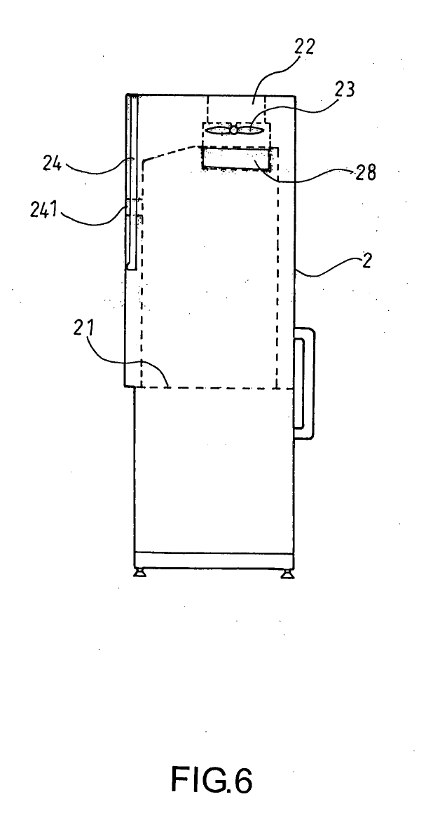

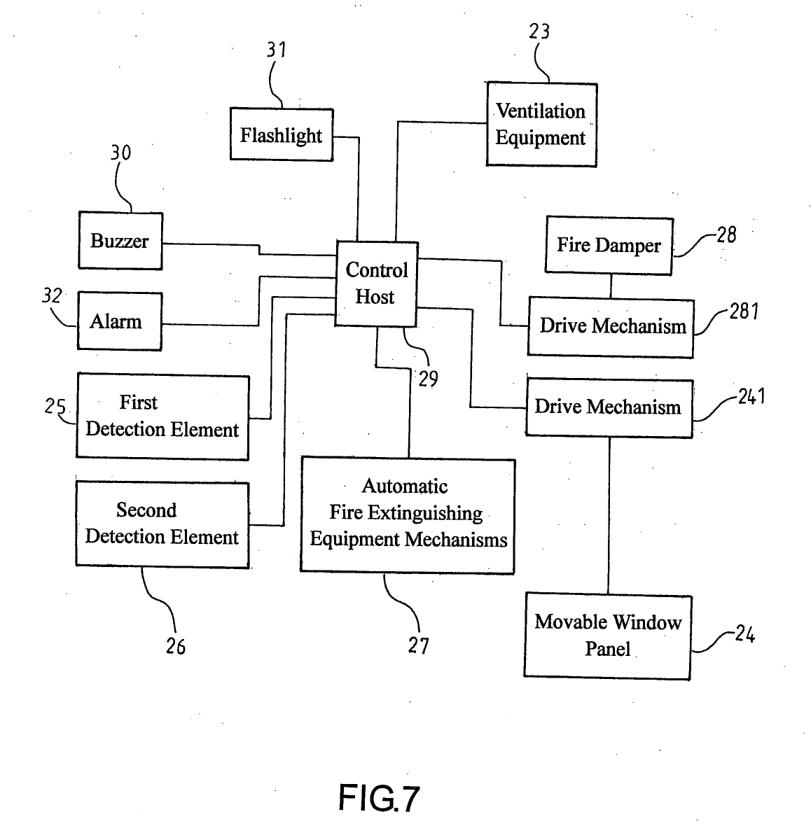

Referring to FIG. 4 and FIG. 5, in association with FIG. 6 and FIG. 7, the present invention comprises primarily a cabinet 2, which is provided with a workbench 21, above which is provided with a vent pipe 22 with ventilation equipment 23 being located close to a pipe opening of the vent pipe 22, and a front side of which is provided with a movable window panel 24. Top rim of the workbench 21 is provided with a first detection element 25 (which can be a flame detector or other detector for sensing the flame), a second detection element 26 (which can be a smoke or temperature detector), and automatic fire extinguishing equipment mechanisms 27 which are connected to a halon cylinder 271. A front end (or a rear end) of the ventilation equipment 23 is provided with a fire damper 28 which is driven by a drive mechanism 281.

The first detection element 25, the second detection element 26, the automatic fire extinguishing equipment mechanisms 27, and the drive mechanism 281, are connected respectively to a control host 29 which interprets a detected signal to control closure of the ventilation equipment 23, the fire damper 28, and the movable window panel 24, as well as a spraying operation of the automatic fire extinguishing equipment mechanisms 27. The control host 29 is connected with a buzzer 30, a flashlight 31, and an alarm 32.

By assembling the aforementioned components, when fire occurs accidentally at the workbench 21 from chemical experiments, the fire signal can be first detected by the first detection element 25, and then is interpreted by the control host 29, followed by issuing alarming sound or alerting flash from the buzzer 30 or the flashlight 31. Next, the drive mechanism 281 will drive the ventilation equipment 23 to stop operation, and close the fire damper 28 to close the vent pipe 22, so as to prevent thick smoke and flame from channeling into the vent pipe 22, which results in burning other connected fume hoods or processing equipment to cause a severe disaster. When the thick smoke or high temperature signal is detected by the second detection element 26, the signal will be interpreted by the control host 29, followed by issuing the alarming sound from the alarm 32. Next, the drive mechanism 241 will drive the movable window panel 24 to close, and activate the automatic fire extinguishing equipment mechanisms 27 to spray out halon for terminating the flame, so as to prevent the thick smoke and flame from channeling into the vent pipe 22, which results in burning other connected fume hoods or processing equipment to cause a severe disaster; therefore, the fume hood will actually achieve a fire-proof effect. The aforementioned control host 29 is provided with an activation device for manually opening the fire damper 28 and the ventilation equipment 23, such that after the fire is extinguished, the fire damper 28 and the ventilation equipment 23 can be opened to expel hazardous gases. In addition, the control host 29 is provided with an emergency activation device and an emergency shutdown device that can manually activate or stop spraying the halon from the fire extinguishing equipment in an urgent condition, so as to allow an operator to manually operate the spraying of the halon when he or she is on-site, or to manually stop spraying the halon according to determination of an on-site personnel that the fire has been extinguished.

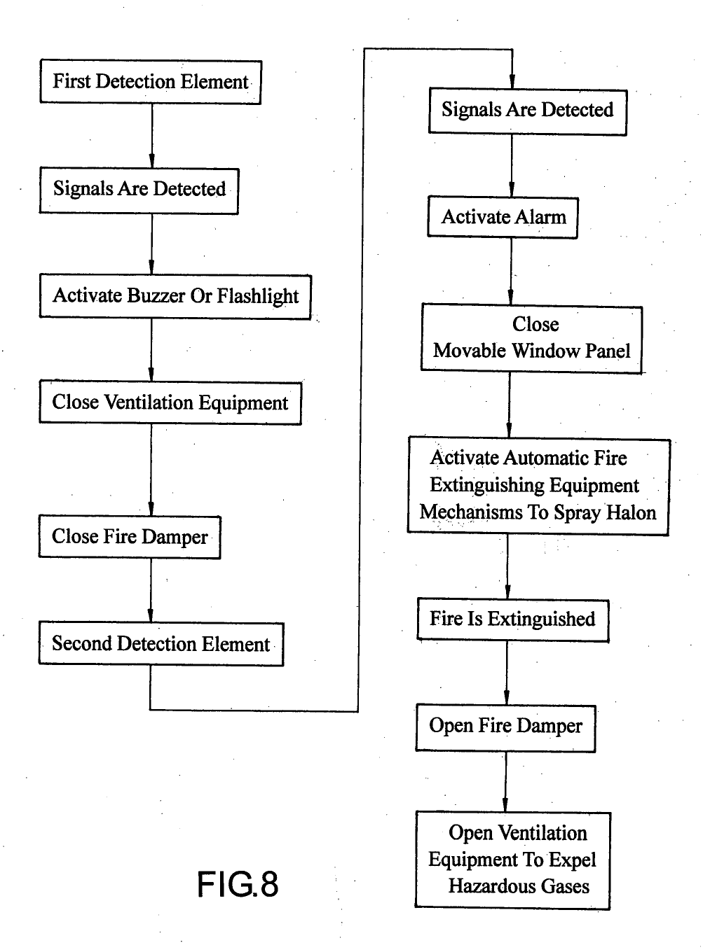

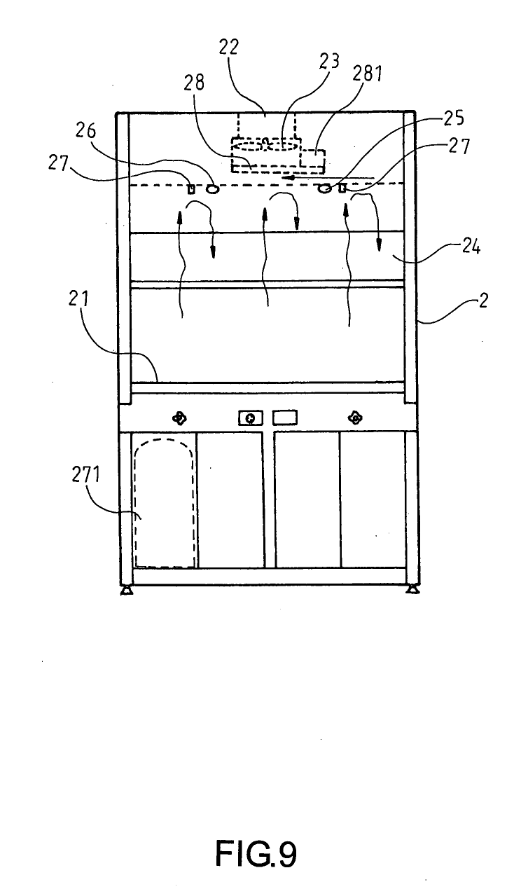

Referring to FIG. 8 and FIG. 9, when the fire occurs from chemical experiments, the fire signal is first detected by the first detection element 25 and transmitted to the control host 29. After the interpretation of the control host 29, the alarming sound or alerting flash will be issued by the buzzer 30 or the flashlight 31. Next, the drive mechanism 281 will be activated to shutdown the ventilation equipment 23 and close the fire damper 28 to close the vent pipe 22, so as to prevent the thick smoke or flame from channeling into the vent pipe 22, which results in burning other connected fume hoods or processing equipment, and allows the thick smoke to circulate and spread over space of the workbench 21 due to the closure of vent pipe 22, thereby enabling the cabinet 2 to form closed space to constitute a smoke or heat accumulation area, thereby facilitating the detection of the second detection element 26.

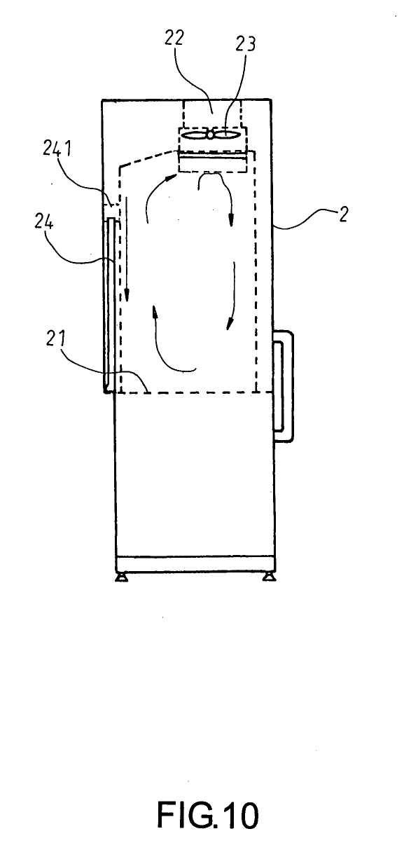

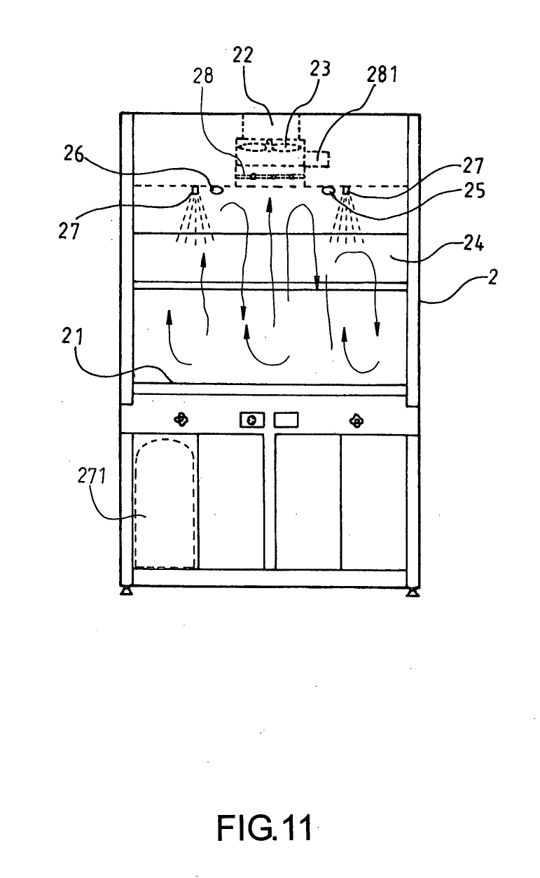

Referring to FIG. 10 and FIG. 11, in association with FIG. 8, when the thick smoke forms the smoke or heat accumulation area which circulates and spreads over the space of the workbench 21, due to the closure of vent pipe 22, the second detection element 26 will accurately detect the thick smoke or high temperature signal which is interpreted by the control host 29, followed by issuing the alarming sound from the alarm 32, and then by activating the drive mechanism 241 to close the movable window panel 24, along with activating the automatic fire extinguishing equipment mechanisms 27 to spray out the halon for terminating the flame, thereby enabling the fume hood to actually achieve the fire-proof effect. After the fire has been extinguished, the fire damper 28 and the ventilation equipment 23 will be manually opened with the activation device of the control host 29, to expel the hazardous gases.

Accordingly, the present invention employs the double-loop detection elements, in association with the movable fire damper and the window panel, to allow the fume hood to achieve the purpose of preventing from starting a cascade of fire, thereby further enabling the automatic fire extinguishing equipment of the fume hood to actually achieve the fire-proof effect.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. Automatic fire extinguishing equipment of a fume hood comprising a cabinet which is provided with ventilation equipment, a movable window panel, a fire damper, automatic fire extinguishing equipment mechanisms by spraying halon, and a control host; the cabinet being disposed with a first detection element for detecting a fire signal; the cabinet being disposed with a second detection element for detecting a smoke or high temperature signal; the microcomputer host which is connected to the first and second detection elements, being used to interpret the detected signal of the first detection element, for closing the ventilation equipment and the fire damper according to results of interpretation, enabling the cabinet to form closed space for constituting a smoke or heat accumulation area to facilitate detection of the second detection element; after interpretation of the detected signal of the second detection element, the movable window panel being closed, and the automatic fire extinguishing equipment mechanisms being activated to spray out the halon for terminating the fire.

2. The automatic fire extinguishing equipment of a fume hood according to claim 1, wherein the first detection element is a flame detector or other detector that senses the flame, in order to detect a flame signal momentarily.

3. The automatic fire extinguishing equipment of a fume hood according to claim 1, wherein the second detection element is a smoke or temperature detector, to detect a smoke or high temperature signal.

4. The automatic fire extinguishing equipment of a fume hood according to claim 1, wherein the fire damper of the vent pipe, the ventilation equipment, and the window panel, are connected respectively to a drive mechanism which controls a closure operation of the ventilation equipment, the fire damper, and the movable window panel according to results of interpretation of the control host.

5. The automatic fire extinguishing equipment of a fume hood according to claim 1, wherein the control host is provided with an activation device for manually opening the fire damper and the ventilation equipment, to expel hazardous gases after the fire has been extinguished.

6. The automatic fire extinguishing equipment of a fume hood according to claim 1, wherein the fire damper is located at a front end or a rear end of the ventilation equipment, to facilitate closing the vent pipe.

7. The automatic fire extinguishing equipment of a fume hood according to claim 1, wherein the first and second detection elements are located at a smoke or heat accumulation area at a top end of the cabinet.
